(19) United States
(12) Patent Application Publication
(10) Pub. No.: US 2007/0214037 A1
(43) Pub. Date: Sep. 13, 2007

(54) System and method of obtaining and using anonymous data

(76) Inventors: Eric Shubert, Pleasanton, CA (US); Darcy Frew, Pleasanton, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/715,006

(22) Filed: Mar. 6, 2007

Related U.S. Application Data
(60) Provisional application No. 60/781,535, filed on Mar. 10, 2006.

(51) Int. Cl. G07G 1/00

(52) U.S. Cl. 705/10

(57) ABSTRACT

A system and method that anonymously collects and uses consumer purchase data, including radio frequency metrics, linked to individual characteristics, including demographic and attitudinal profiles of each user, while protecting individual user's identities. Uniquely identifying information about the user is not requested or recorded, keeping individual users anonymous and protected from unrequested solicitations, identity theft, and disclosure of individually identifying information to any third party. This data can then be used for a variety of purposes, including mass marketing, individually targeted marketing, and market research.

### RELATED APPLICATIONS

This application claims priority of U.S. Provisional application No. 60/781,535 filed Mar. 10, 2006, which is incorporated by reference in its entirety.

### BACKGROUND OF THE INVENTION

1. Field of the Invention

Embodiments of the present invention relate generally to consumer data collection and use, and more particularly to anonymous radio frequency collection of consumer data.

2. Description of the Prior Art

Prior art approaches to consumer data collection include the collection of unique identifying personal information, such as a person's full name, complete address, social security number, phone number, and complete birth date.

The prior art for collecting and using consumer purchase data is limited to representative sample groups and major grocers and wholesalers club cards. Loyalty, rewards, and club cards ask users to individually identify themselves by providing their name, address, phone number, and driver's license number. Not only is this dangerous for the consumer, due to identity theft, and unrequested solicitations, but law enforcement subpoenas have already proven successful in identifying individual's purchases and purchasing behaviors and connecting these purchases and behaviors to possible criminal actions, irrespective of actual criminal actions. Additionally, prior art representative sample groups are inherently inaccurate and are not scalable.

The growing problem of identity theft, however, has resulted in many people not sharing or falsifying such data. Additionally, many people do not have the time or the incentive to cooperate with consumer data collection. This problem is further compounded by each merchant having its own consumer data collection program.

Methods exist in the art to obtain and use demographic and consumer purchase data. However all of these methods require the user to provide at least one uniquely identifying personal fact, such as name, street address, city, phone number, and typically numerous other personal facts such as income, birth date, and household size. There have been many efforts to restrict or ban this activity at both state and federal levels to help protect consumer privacy. Conversely, much of the private consumer data that marketers, retailers, and others seek is useful to them, and can ultimately benefit the consumer as well. For example, by knowing their customers' spending and buying habits, retailers can utilize this data to provide the optimal product assortment, inventory, promotions and pricing, etc. They can also determine the effectiveness of their marketing programs by gauging repeat rates, promotion response and sales trends. In addition, further consumer segmentation can be performed based on consumer demographic information which will enable marketers to provide focused efforts on specific demographic groups and enable enhanced marketing efforts to particular consumers based on variables such as geographical location, age of consumer, gender of consumer, etc. This will allow retailers to become more efficient with their marketing expenditures and allow for individually targeted marketing of specific consumers and groups of consumers.

Unfortunately, while the collection and analysis of such data can be of great public benefit, it can also be the subject of considerable abuse. The reason some or many of these uniquely identifying personal information questions are included is because through data aggregation using many different data sources, including credit reports, mailing lists, telemarketing lists, etc., this information can be used as additional revenue streams for companies involved in market research and advertising. While it is agreed that consumer demographic and attitudinal information is invaluable to manufacturers, retailers and marketers alike, interestingly, none of this uniquely identifying personal information is necessary to obtain, analyze and effectively utilize demographic, attitudinal, purchase, and other forms of market research data. Additionally, some of the uniquely identifying information volunteered by consumers has been used to further the growing problem of identity theft, as well as cause unwanted solicitations and the disclosure of sensitive individually identifying information and purchasing behavior to third parties. Unwanted and/or unrequested solicitations relating to the collection of consumer data can include any unsolicited contact, including telemarketing, direct phone calls, direct mail, third party mailing lists, and e-mail spam. These problems have limited consumer interest and curtail participation in these data collection efforts.

Another commonly utilized method for collecting and analyzing consumer demographic information linked with purchase data is through the use of sample groups. Representative sample groups are typically less than a fraction of 1% of a given consumer population. The demographics and purchase behavior of this small group of consumers is then modeled to predict the demographics and purchase behavior of the total population. This method has resulted in limited accuracy and usefulness of the modeled data.

3. Discussion of Prior Art

The existing art includes methods such as the Harms patent (U.S. Pat. No. 6,070,147) which is a “customer identification and marketing analysis system.” Unfortunately, this system ensures that uniquely identifying information is collected when consumers participate. This method, as well as others like it, such as Wong (U.S. Pat. No. 6,119,993) puts participating customers at risk for unwanted solicitations, identity theft, and the disclosure of individually identified sensitive information to third parties.

Attempts have been made to reduce the likelihood of unwanted solicitations and identity theft. For instance, the Veldhisen patent (U.S. Pat. No. 6,480,850) collects uniquely identifying information, but attempts to keep that information stored in another location from publicly available information. This type of system is cumbersome and still does not eliminate the potential for disseminating participants' uniquely identifying information.

The Fusz application (United States Patent No. 20040176995) provides a method for consumers to provide themselves with marketing data via generating an anonymous consumer profile. However, this method is designed to provide only the consumer with marketing data, not to obtain and use anonymous consumer purchase, demographic, attitudinal and other consumer data.

Therefore, there exists a need in the field of marketing, market research to provide a method and system of obtaining and using anonymous consumer purchase, demographic, attitudinal, and other consumer data, as well as a method for eliminating unrequested solicitations, identity theft, and the protection of an individual's identity and their associated sensitive and confidential purchasing information from being disclosed to any third party relating to the collection of consumer data.

### SUMMARY OF THE INVENTION

The invention is based on new methods for collecting consumer data and providing manufacturers, retailers and marketers, and others with private and/or confidential consumer data that can provide a clear understanding of their actual customers as anonymous individuals, groups, or as specific subgroups, including information about their customers' geography, buying habits, demographics, etc., while protecting the privacy and identity of individual consumers. The term “consumer” can include anyone who purchases a product or service either for themselves, for others, or for any kind of business. This method employs a database that will combine the anonymous consumer information such as demographics with actual consumer purchases at participating retailers. Accordingly, this invention does not utilize uniquely identifying personal information that can potentially result in unwanted solicitations, identity theft, and disclosure of individually identifying information to third parties. As such, it is anticipated that this system and method will create consumer confidence in revealing useful, yet non-uniquely identifying data and opinions. It is also anticipated that this method will increase consumer confidence and participation in consumer data collection and utilization efforts, which will in turn increase the accuracy and usefulness of the information.

From this anonymous database, anonymous consumer demographic, attitudinal, radio frequency metrics, and other data generated from the use of the method and the system combined with their actual purchase data at participating retailers (the accuracy of consumer purchase behavior information) will be significantly increased well beyond traditional sample group methods used today. FIG. 6 demonstrates how each individual participating consumer's demographic and purchase data will be aggregated and provided to merchants and/or manufacturers for use in, but not limited to, marketing analysis, consumer behavior reports, and modeling. This consumer purchase behavior data will be used by manufacturers, retailers and others in any variety of marketing and market research applications such as category management, demographic segmentation, demographic clustering, predictive modeling, promotion evaluation, individually targeted marketing, pricing optimization, and product assortment analysis. Such detailed information also enables retailers to enhance their products and services offered to consumers and facilitate a better shopping experience for consumers while assisting retailers in meeting company goals through increased sales and profits.

### Short Description of the Invention

This invention relates to a novel system and method of obtaining and using anonymous consumer data that comprises providing a multi vendor capable instrument, such as a uniquely identifiable card, to the consumer for use during consumer purchases. The consumer may then be invited to anonymously register the instrument (e.g. card). This registration process will invite the user to provide anonymous demographic data, such as gender, age ethnicity, education, household size, marital status, income, and zip code. Uniquely identifying information, such as, but not limited to, name, street address, birth date, phone number, social security number, driver's license number, or e-mail will not be requested.

It is anticipated that participating retailers will institute reward/loyalty programs. One example of a program will be reducing the price of certain items to consumers who use the card, to motivate consumers to use the card when making purchases. Another example is that consumers' will earn points for items purchased at the retailer. Consumers can then redeem points earned at retailers for products and services at any of the participating retailers.

When consumers use the card during purchases, sales information is automatically captured at the point of sale. Then, the demographic and other consumer data, and the consumer purchase information can be linked in one central database to obtain a clear picture of the purchase behavior of the consumers that made the purchases. This information can then be used for a variety of purposes, including market research.

### Detailed Description of the Invention

An instrument with a unique identifier is provided to a user. In one embodiment, the user of the instrument is an individual who shops or browses for goods and/or services at one or more places of business where goods and/or services are sold, such as a retail store, and who may or may not consummate the act of shopping or browsing with an actual purchase. In one embodiment, the user is a consumer of goods and/or services and the place of business where goods and/or services are sold is a vendor.

In one embodiment the instrument is a credit card-sized card with the unique identifier pre-printed on the card, and stored electronically in the card, by means of a magnetic strip, radio frequency tag or circuit, or other electronic means. The instrument does not have any other individually identifying characteristics associated with the user, such as the user's name, address, social security number, date of birth, phone number, email address, or driver's license number either printed or marked in some way on the outside of the instrument or stored electronically in some way on or inside the instrument.

In one embodiment, the user is given an instrument free of charge while physically on the premises of a place of business that sells consumer goods and/or services. Preferably, the instrument can be used at a plurality of places of business where consumer goods and/or services are sold.

Anonymous data provided by the user of the instrument is collected. In one embodiment, anonymous data about the user, provided by the user, is collected when the user anonymously registers the instrument by means of communicating with a computer system via a data transmission network-enabled user interface such as a website, kiosk, PDA, or Smartphone. During the communication, the user provides the unique identifier associated with the user's instrument, enabling all subsequently collected anonymous data to be associated with the user's unique identifier that is related to the user's instrument.

In order to ensure the anonymity of the user, identifying information generated from communication with the user is deleted. Any identifying information, such as an IP address, or MAC address, not voluntarily provided by the user, yet identifiable as a result of the user's communication with, in one embodiment, a computer system via the use of a data transmission network-enabled user interface, is deleted from the computer system at the end of the user communication.

In one embodiment, the collected user-provided anonymous data comprises answers to demographic questions such as the user's gender, zip code, ethnicity, education, household size, marital status, age, and income, while the user does not provide any individually identifying characteristics associated with the user, such as the user's name, address, social security number, date of birth, phone number, email address, or driver's license number. The user establishes communication with, in one embodiment, a computer system via the use of a data transmission network-enabled user interface, and provides the unique identifier associated with the user's instrument. Preferably the user then provides answers to anonymous demographic questions. The user-provided answers to anonymous demographic questions are linked to the unique identifier associated with the user's instrument and are stored, in one embodiment, in an electronic file on a computer system.

In one embodiment, the collected user-provided anonymous data comprises responses to questions resulting from the user's participation in a survey. The survey questions are designed so that user answers do not individually identify the user. The user establishes communication with, in one embodiment, a computer system via the use of a data transmission network-enabled user interface, and provides the unique identifier associated with the user's instrument and then provides answers to anonymous survey questions. The user-provided answers to anonymous survey questions are linked to the unique identifier associated with the user's instrument and are stored, in one embodiment, in an electronic file on a computer system.

In one embodiment, the collected user-provided anonymous data comprises responses to questions resulting from the user's participation in a focus group. The focus group questions are designed so that user answers do not individually identify the user. The user provides the unique identifier associated with the user's instrument to the focus group moderator, and then provides answers to anonymous focus group questions. The user-provided answers to anonymous focus group questions are linked to the unique identifier associated with the user's instrument and are stored, in one embodiment, in an electronic file on a computer system.

In one embodiment, users are given incentives to increase their purchases at one or more vendors. The incentives can be product price reductions where a product refers to an item in a vendor's place of business and price reductions refer to a discounted price of some kind given to the user. In one embodiment, additional incremental discounts are given to users based on their volume of purchases; the more they buy the bigger the discount they receive.

In one embodiment, incremental product price reductions are given based on the user's cumulative purchases at a plurality of vendors and vendor locations.

In one embodiment, the incentive given to a user can include points based on each dollar spent on product purchases. The points can be redeemed for merchandise.

In one embodiment, incentives can be given to users as rewards for participating in surveys and focus groups.

In one embodiment, data is obtained from vendors comprising a vendor's inventory data, pricing data or product location data. A vendor's inventory data is data relating to the items that a vendor has available to sell in their place of business, items that are immediately available for sale, and/or items that have to be ordered first and then sold. A vendor's pricing data comprises the current price of an item for sale, and the price that the vendor may be willing to sell the item, based on a competitive pricing model or algorithm. A vendor's product location data is data relating to the physical location of the item in the actual place of business. The data can also include if the vendor has more than one place of business, and the product location inside the place of business.

In one embodiment, the vendor's data is processed by means of a computer system and made available anonymously to users via a user interface comprising one or more of the following: kiosk, PDA, or Smartphone. In one embodiment, users provide lists of their needs and wants with respect to items for consumption and a shopping list is organized by the user's preferences such as lowest price, total travel time and distance, or availability.

In one embodiment, the user transfers funds to the instrument so that the instrument can be used for anonymous purchase payment at a vendor. The user transfers the funds utilizing one or more of the following: cash, a wire transfer, or an electronic transfer of some kind.

In one embodiment, one or more user biometrics such as fingerprint, retinal data, or facial data, is used to anonymously identify and link the user to the instrument, so long as the user biometric does not exist in any other database associated with the actual identity of the user.

The use of the instrument by a user generates data related to the anonymous instrument's use in a system that comprises the instrument, one or more product tags that contain unique identifiers, a means to communicate with the product tags, and a means to communicate with the anonymous instrument.

In one embodiment, the system is comprised of one or more radio frequency antennas located throughout the premises of a place of business where goods and services are sold, and at each point of sale device where purchases and/or returned items are processed.

In one embodiment, the data generated from the use of the instrument comprises data related to a user's purchases. The user's purchase data includes one or more of the following: the times, locations, items, prices, or discounts of the user's purchases. In one embodiment, the unique identifier associated with the user's instrument is identified at the point of purchase and is linked to the user's purchase data and is stored in an electronic file in a computer system.

In one embodiment, the data generated from the use of the instrument comprises data related to the user's instrument's location within a place of business, and/or the user's interaction with one or more of the goods/and or services located on the premises, identified by radio frequency product or item tags.

In one embodiment, the data collected from the system and/or the method is used for marketing and research including market research.

The use of the system and the method has the following advantages to the user:
a. Protecting an individual's anonymity relating to the collection and use of user/consumer data;
b. Collecting and using user/consumer data without disclosure of individually identifying information to any third party;
c. Preventing third parties from identifying an individual relating to the collection and use of user/consumer data;
d. Eliminating unrequested solicitations relating to the collection and use of user/consumer data; and
e. Eliminating the risk of identity theft relating to the collection and use of user/consumer data.

The use of the system and the method has the following advantages in marketing and marketing research:
a. Little user resistance to mass collection of user/consumer data;
b. Scalable to near-census level, making representative sample groups obsolete;
c. Business Intelligence provided to manufactures, wholesales, retailers is significantly more accurate than prior art;
d. Scalable, individually targeted marketing to users/consumers; and
e. Significant improvement in marketing conversion and penetration rates, due to individually targeted marketing to users/consumers.

### BRIEF DESCRIPTION OF DRAWINGS

FIG. 1. FIG. 1 shows an exemplary system and method for anonymous radio frequency collection of consumer data utilizing an anonymous user instrument, herein referred to as a key card.

FIG. 2. FIG. 2 shows an exemplary radio frequency session metric system utilizing an anonymous user instrument, herein referred to as a key card.

FIG. 3. FIG. 3 shows an exemplary user shopping network utilizing an anonymous user instrument, herein referred to as a key card.

FIG. 4. FIG. 4 shows an exemplary anonymous purchase payment method utilizing an anonymous user instrument, herein referred to as a key card.

FIG. 5a. FIG. 5a identifies the demographic data typically obtained using previously existing methods.

FIG. 5b. FIG. 5b identifies the anonymous demographic data typically obtained using the method described herein.

FIG. 6. FIG. 6 shows a consumer's buying behavior matched to their anonymous demographic data.

### DETAILED DESCRIPTION OF THE DRAWINGS

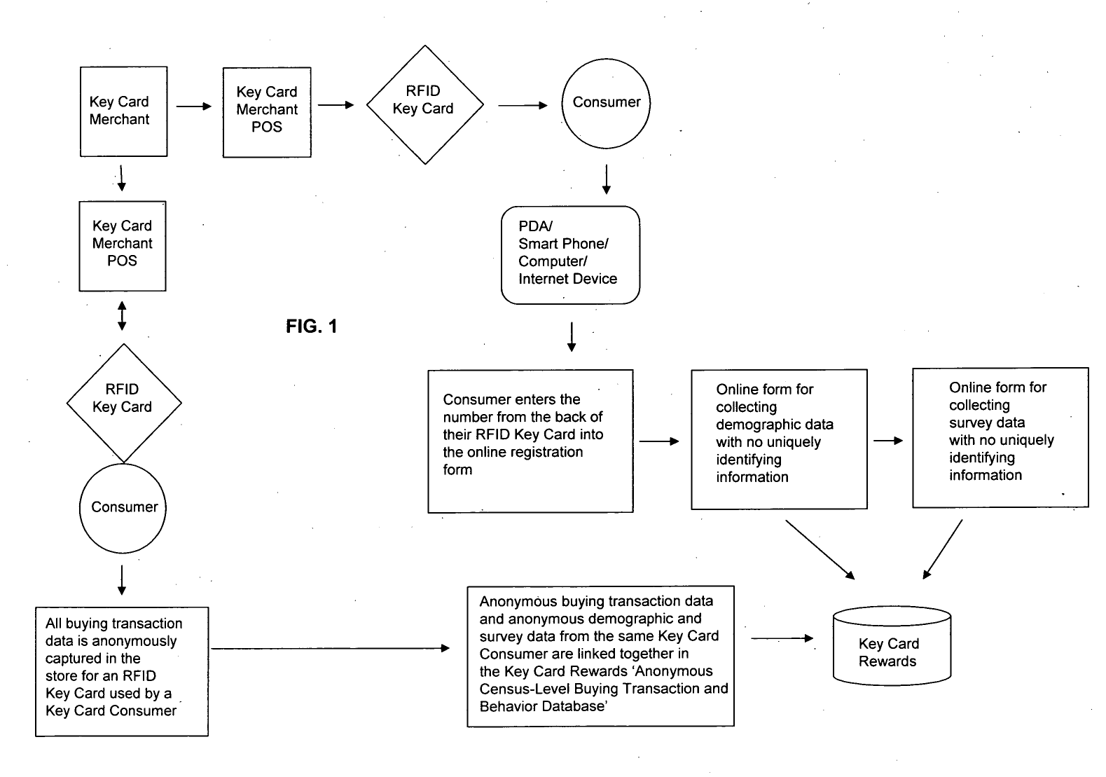

FIG. 1. Referring to FIG. 1, an exemplary system and method for anonymous radio frequency identification (“RFID”) collection of consumer data is shown. FIG. 1 shows a consumer an anonymous instrument (e.g. a key card), a key card merchant point of sale (“POS”) device, a computing device, and an incentive or rewards program for the consumer's use of the key card. FIG. 1 also illustrates exemplary steps by which the consumer anonymously registers for the incentive or rewards program for the consumer's use of the key card.

The consumer obtains an exemplary RFID card, known as the key card, from the vendor (e.g. key card merchant). The key card merchant distributes the key cards at little or no cost to the consumer. The consumer uses the key card when visiting and/or engaging in transactions, such as purchases, with one or more of the key card merchants.

Upon obtaining the key card from the key card merchant, the consumer is entitled to receive incentives or rewards in connection with purchases made with the key card from the key card merchants. Because the consumer uses the key card with a plurality of key card merchants, the consumer saves time by not having to participate in separate consumer data collection programs for each merchant.

The incentives or rewards the consumer receives as a result of using the key card in connection with purchases may comprise a three-tier program. Each tier rewards the consumer based on the monetary value of purchases made by the consumer with the key card. Tier one comprises an instant discount for the consumer in connection with each purchase made with the key card at each key card merchant. Tier two comprises an additional discount in the form of an in-store credit for the consumer at the key card merchant after the consumer reaches a cumulative monetary value of purchases from the key card merchant. Tier three comprises the consumer earning redeemable points for gifts based on the consumer cross-shopping at a plurality of key card merchants. In further embodiments, the consumer uses the key card for as many as three purchases at one or more key card merchants before the consumer is required to register the key card in order to receive further incentives or rewards.

According to various exemplary embodiments, the consumer registers the key card as part of a registration process wherein the consumer's identity remains anonymous. The registration of the key card may require the consumer to enter data in response to questions included on an Internet website located at an Internet address printed on the key card. The questions on the Internet website request the consumer to enter a unique number appearing on the key card. The questions on the Internet website also request data that allows the consumer to remain anonymous, such as zip code and birth year of the consumer, rather than unique identifying personal information from the consumer, such as the consumer's full name, complete address, social security number, phone number, and complete birth date.

The information requested as part of the registration process is unlikely to reveal unique identifying personal information, since the consumer is not required to provide any details related to the consumer's identity. As a result of the anonymous registration process, the consumer may feel protected, empowered, and rewarded to disclose demographic and attitudinal information, such as surveys and focus groups.

According to some embodiments, anonymous surveys can be initiated automatically or at the request of a merchant or manufacturer that will give further insight into consumer shopping behavior and attitudes.

The surveys can be omnibus or targeted to specific shopping groups based on any number of variables relating to buying behavior and demographics, while keeping individual survey responses completely anonymous. In one example, these surveys will be fielded via the same internet site where consumers originally registered their card. Consumers may be invited to participate in a survey. Because no uniquely identifying information is collected on the website, responses to the survey remain completely anonymous.

Further, if the consumer misplaces or otherwise no longer has access to the key card, the consumer can obtain another key card and re-register, without having to cancel the previous key card.

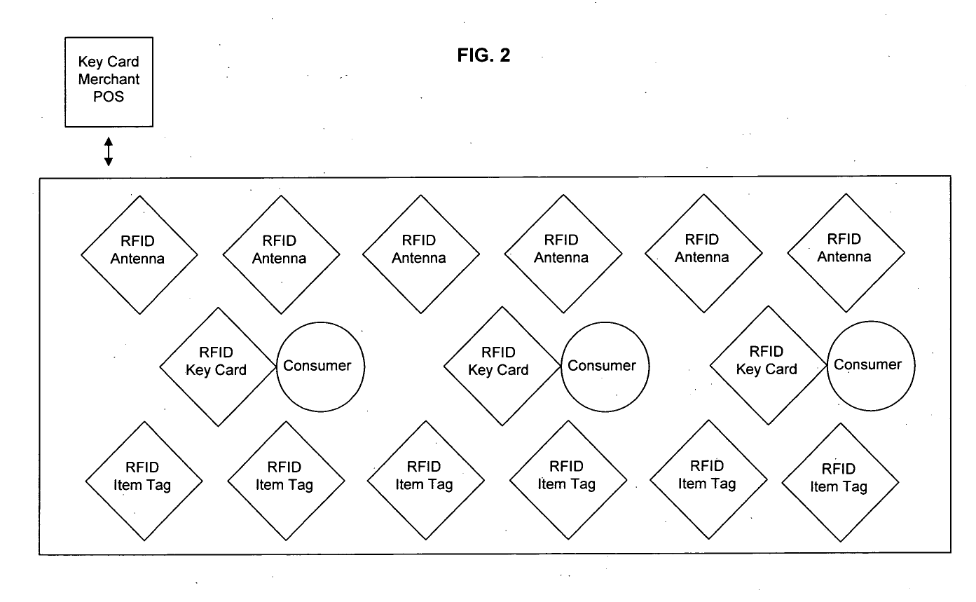

FIG. 2. Referring to FIG. 2, an exemplary anonymous instrument (e.g. key card) session metric system is illustrated. A plurality of networked RFID antennas, a plurality of RFID item tags, a key card merchant POS device, and a plurality of consumers with key cards are shown in FIG. 2.

According to exemplary embodiments, the anonymous instrument (e.g. key card) records the consumer's interactions with respect to the RFID item tags associated with the key card merchant's inventory. The key card then transmits the recorded interactions to the networked RFID antennas located in the key card merchant's place of business. The networked RFID antennas transmit the recorded interactions to the key card merchant's POS device.

The exemplary key card session metric system tracks data such as when the consumer touches, picks-up, puts down and/or purchases an article of the key card merchant's inventory. Additionally, the exemplary key card session metric system tracks the amount of time the consumer spends making a purchase decision with respect to a particular article of the key card merchant's inventory, and tracks the amount of time the consumer spends in various areas of the key card merchant's place of business. The key card merchant anonymously collects the data without the consumer's awareness of the process and without the key card merchant having to compensate the consumer for the consumer's active participation. Additionally, the consumer data collected reflects the consumer's impulse-based purchases.

The key card merchant uses the data captured by the exemplary key card session metric system to optimize merchandise placement within the key card merchant's place of business. For example, the key card merchant may use the collected data to determine where to place certain displays at the key card merchant's place of business. The key card merchant might also use the data captured by the exemplary key card session metric system to optimize revenue per square foot of the key card merchant's place of business by reallocating square footage to certain inventory items.

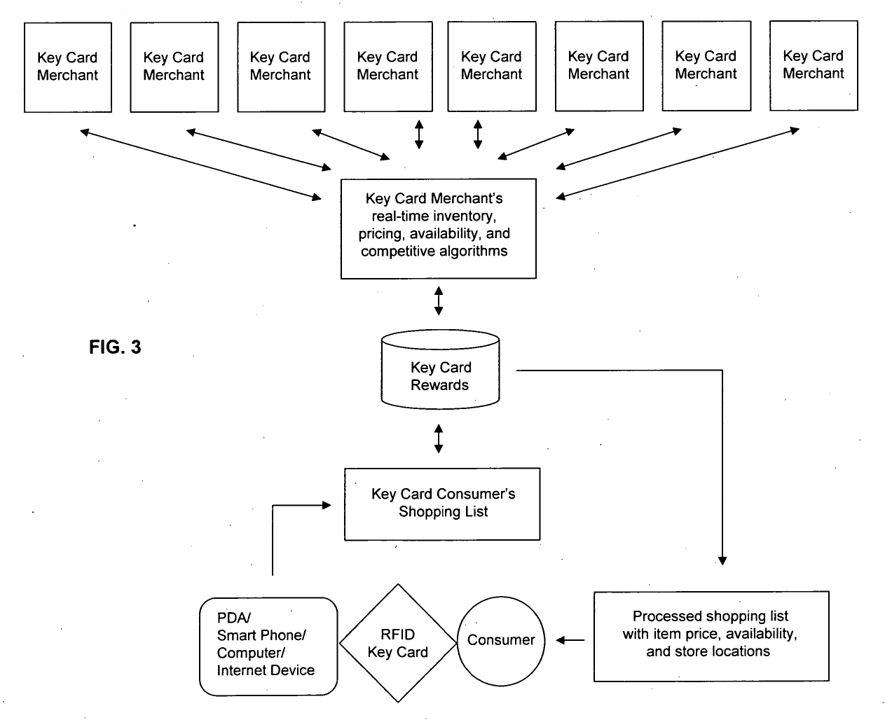

FIG. 3. Referring to FIG. 3, an exemplary user shopping network is shown, comprised of all the vendors (e.g. key card merchants) in any geographical location, all the anonymous instrument users (e.g. key card consumers) in any geographical location, and a key card central computer.

A real-time database is kept in the central computer for each merchant's inventory, complete with any and all product descriptions, pricing, availability, and any competitive algorithms for lowering the price of a particular item on a case by case basis, for example, in a bidding competition, or any other eventuality wherein the price of a particular item is designated to be dynamic by the merchant. Any other information that would be useful to a consumer making a buying decision, as described below, is kept in the database.

Additionally, for each consumer, a software application is available and accessible by any internet connection, that allows the consumer to virtually browse, by written descriptions, pictures, pre-recorded and/or live video and audio, and any other communication medium that can be transmitted via a data transmission network of any kind, so as to assist the consumer in creating a shopping list for items to be purchased now, and also items that will be purchased in the future, and also items that are placed on a ‘wish list.’

Any of the items on any of these shopping lists can be shown in detail by store, location, hours of operation, address, driving directions, price, quantity available, shipping methods and availability, payment options including financing, competitive pricing discounts, sales and sales pitches, multiple merchant bidding discounts, key card discounts and rewards, reviews, recommendations, testing results, opinions, testimonials, and any other information that would be useful to a consumer making a buying decision.

Once the shopping list for items to be ‘purchased now’ is complete, a finished list view will enable the consumer to commence a shopping trip, ordered by store, items to be purchased, driving directions with route planning, shipping confirmations and tracking numbers, and any other convenience and assistance that would be helpful to a consumer.

Finally, feedback from the consumer regarding any experience related to any product or service and the overall shopping process can be communicated back to the central computer to be incorporated into the real-time database, allowing other consumers and merchants to incorporate this new data into offerings and purchases.

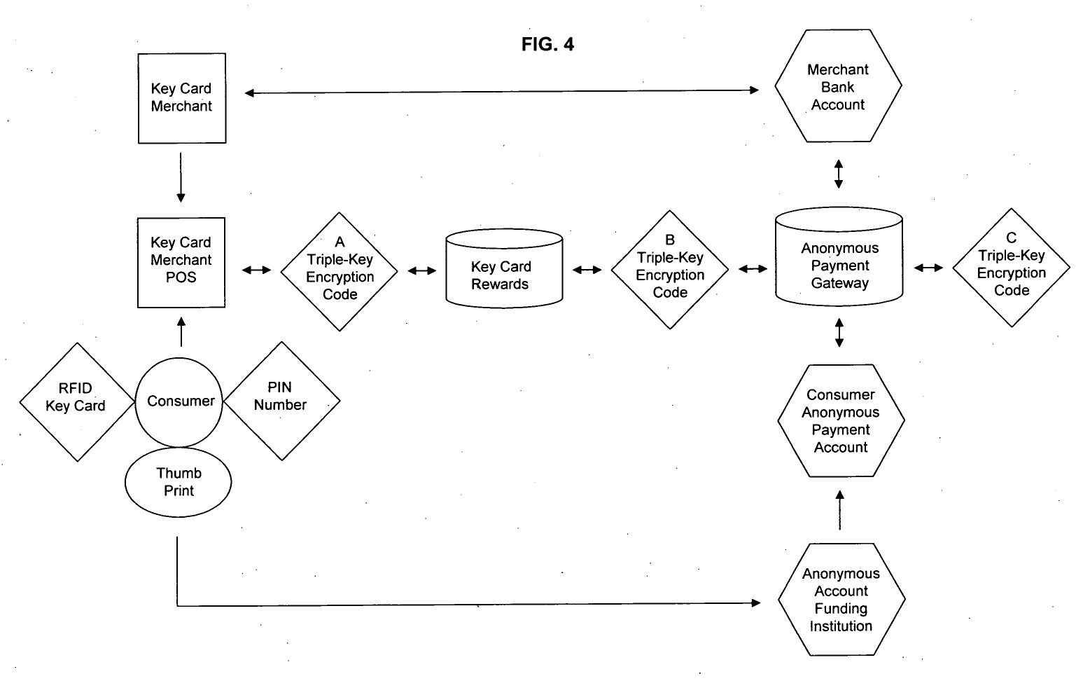

FIG. 4. Referring to FIG. 4, an exemplary anonymous purchase payment method is shown. When a consumer pays for any product or service at any vendor (e.g. key card merchant), the consumer has a choice to use the anonymous instrument (e.g. key card) for payment. Each consumer's key card can be linked to a bank account that has no uniquely identifying personal information associated with it in any way, other than the unique key card number, a unique number generated by the thumbprint or other biometric signature, and a PIN number, chosen by the consumer.

When an anonymous payment account is opened at any authorized key card merchant, the consumer only needs to present their key card, their thumbprint and choose a PIN number that is entered secretly into a computer system. Initially, until anonymous account funding institutions and other anonymous payment gateways and options for anonymous funding are built, a consumer can bring in their own anonymous funds, from time to time, such as cash.

Whenever a product or service is sold at a key card merchant, and the key card is used to make payment, the following occurs at the point of sale:
1) The consumer presents their key card
2) The consumer allows their thumbprint to be scanned
3) The consumer enters their PIN number secretly on a PIN pad Payment transaction data is then transmitted to a central computer using a triple-key encryption code, generated in part by the unique identifying number of the point of sale device, to ensure the point of sale device is authentic.

The central computer then transmits the payment transaction data to the anonymous payment gateway central computer using another triple-key encryption code, generated in part by the unique identifying number of the central computer, to ensure the computer is authentic.

The anonymous payment gateway central computer then transmits the payment transaction data using yet another triple-key encryption code, generated in part by the unique identifying number of the anonymous payment gateway central computer, to ensure the computer is an authentic, to the central computer of the financial institution that holds the actual anonymous payment account information.

If all three triple-key encryption codes are authentic and the key card number, thumbprint, and PIN number all match the same key card number, thumbprint and PIN number given when the anonymous payment account was opened, and there are sufficient funds in the anonymous payment account for the payment transaction, the money for that transaction is transferred to a bank account of the merchant's choice.

This entire process works in reverse for a credit issued by a merchant to a consumer for a return or other merchant authorized credit to a consumer.

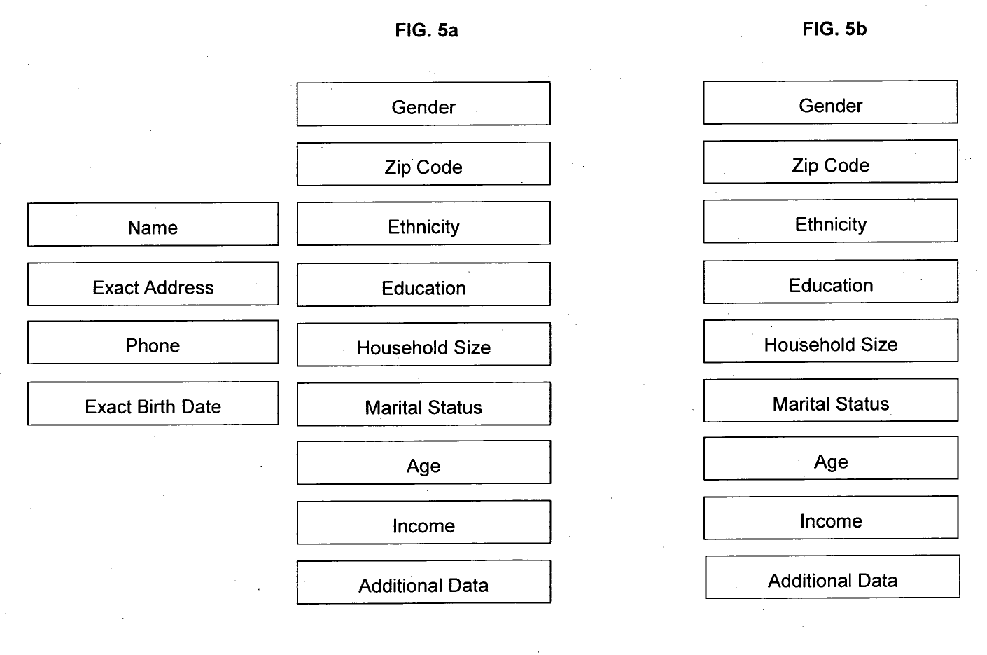

FIG. 5a. FIG. 5a illustrates how consumer data has been traditionally collected, which includes uniquely identifying each consumer, in contrast to the method of collecting anonymous consumer data. For example, while existing methods may have requested the consumer's zip code and birth year, uniquely identifying personal information, such as name, street address, social security number, exact birth date, phone number etc., would also be requested.

FIG. 5b. FIG. 5b illustrates examples of the anonymous information collected and used in the system and method described herein. This anonymous data cannot be used to obtain uniquely identifying information about the consumer from the information collected during the registration process. People with the same zip code and birth year in any given zip code are generally believed to be non-unique.

This anonymous registration associates a unique card number, (e.g. an alphanumeric character string), or a graphical representation of the same, such as a barcode, with a unique demographic and marketing research profile, comprising additional consumer data. Furthermore, the data obtained from each consumer is more accurate than in other methods because of the anonymity of the user, as well as the knowledge that accurate and honest responses enhance each consumer's shopping experience through lower prices, better selection and better service.

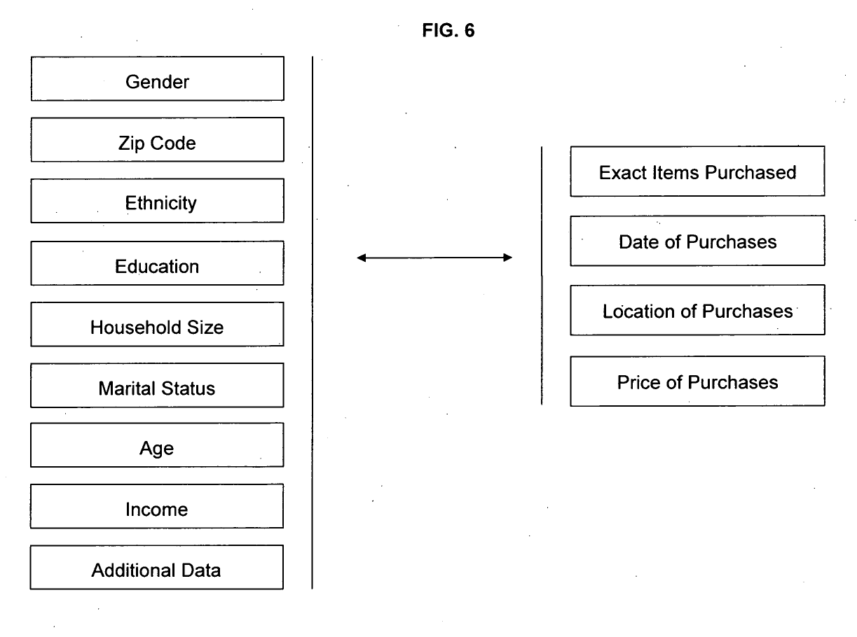

FIG. 6. FIG. 6 shows that from the anonymous database obtained via the system and method described herein, anonymous consumer demographic data can be combined with user's actual purchase data at participating retailers thereby significantly increasing the accuracy of consumer purchase behavior well beyond traditional sample group methods used today. FIG. 6 demonstrates how each individual participating consumer's demographic and purchase data can be aggregated and provided to retailers and/or manufactures for use in, but not limited to, marketing analysis, consumer behavior reports, and modeling. This consumer purchase behavior data can be used by manufacturers, retailers and others in any variety of marketing and market research applications such as category management, demographic segmentation, demographic clustering, predictive modeling, promotion evaluation, individually targeted marketing, pricing optimization, and product assortment analysis. This data will be useful in enhancing consumer's shopping experience while assisting retailers in meeting company goals through increased sales and profits.

While various embodiments have been described above, it should be understood that they have been presented by way of example only, and should not act to limit the scope of the invention. For example, any of the elements associated with the invention may employ any of the desired functionality set forth hereinabove. Thus, the breadth and scope of a preferred embodiment should not be limited by any of the above-described exemplary embodiments.

Moreover, the present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

What is claimed:

1. A method of obtaining and using anonymous data comprising:
a. Providing an instrument that contains a unique identifier to a user;
b. Causing the user to provide anonymous data; and
c. Collecting the data provided by the user.

2. The method of claim 1, wherein use of the instrument generates data.

3. The method of claim 2, further comprising collecting data generated from use of the instrument.

4. The method of claim 3, further comprising linking the anonymous data provided by the user with the data generated from the use of the instrument.

5. The method of claim 1, wherein the instrument comprises a multi vendor capable instrument.

6. The method of claim 1, wherein the instrument comprises a radio frequency device.

7. The method of claim 1, wherein the instrument comprises a smart card.

8. The method of claim 2, wherein the data generated from the use of the instrument comprises the instrument's location within a place of business.

9. The method of claim 2, wherein the data generated from the use of the instrument comprises information related to the user's interaction with items in a place of business.

10. The method of claim 2, wherein the data generated from the use of the instrument comprises radio frequency metrics.

11. The method of claim 1, further comprising establishing anonymous communication with a user and a computer system via a data transmission network.

12. The method of claim 11, wherein upon completion of the communication with the user, all identifying information relating to the communication is deleted from the computer system.

13. The method of claim 1 or 3, wherein the collected data is stored in an electronic file.

14. The method of claim 1, wherein the anonymous data provided by the user further comprises the unique identifier that is associated with the instrument.

15. The method of claim 2, wherein the data generated from the use of the instrument further comprises the unique identifier that is associated with the instrument.

16. The method of claim 1, wherein the user provided anonymous data is facilitated by an data transmission network enabled user interface.

17. The method of claim 1, wherein the anonymous data provided by the user further comprises registering the instrument.

18. The method of claim 16, wherein the data transmission network enabled user interface comprises a website.

19. The method of claim 16, wherein the data transmission network enabled user interface comprises a kiosk.

20. The method of claim 16, wherein the data transmission network enabled user interface comprises a PDA.

21. The method of claim 16, wherein the data transmission network enabled user interface comprises a smart phone.

22. The method of claim 1, wherein the anonymous data provided by the user comprises the user's demographic information.

23. The method of claim 22, wherein the user's demographic information comprises one or more of the following: gender, zip code, ethnicity, education, household size, marital status, age, or income.

24. The method of claim 2, wherein the data generated from the use of the instrument comprises the user's purchase data.

25. The method of claim 1 or 2, wherein the data obtained from the user comprises the user's attitudinal data.

26. The method of claim 25, wherein the attitudinal data comprises data obtained from the user's participation in a survey.

27. The method of claim 25, wherein the attitudinal data comprises data obtained from the user's participation in a focus group.

28. The method of claim 1, further comprising an incentive program.

29. The method of claim 28, wherein the incentive program comprises providing product price reductions to the user.

30. The method of claim 28, wherein the incentive program comprises providing product volume price reductions wherein additional purchases create additional product price reductions for the user.

31. The method of claim 28, wherein the incentive program comprises providing incentives to users to use the instrument at a plurality of vendors and locations.

32. The method of claim 1, 2, or 3, further comprising using the data collected from the method to conduct research.

33. The method of claim 1, 2, or 3, further comprising encrypting the data.

34. The method of claim 1, further comprising:
a. obtaining data from vendors;
b. processing the vendor data; and
c. providing to users access to the processed data.

35. The method of claim 34, further comprising obtaining a user shopping list.

36. The method of claim 34, wherein the vendor data is obtained via a data transmission network.

37. The method of claim 34, wherein access to the processed data is provided to the user via a user interface.

38. The method of claim 34, wherein the data obtained from the vendor relates to one or more of the following: inventory data, pricing data, or product location data.

39. The method of claim 1, further comprising anonymously transferring funds from the user to the instrument.

40. The method of claim 39, wherein the anonymous transfer of funds from the user to the instrument utilizes one or more of the following: cash, wire transfer, or electronic transfer.

41. The method of claim 1, further comprising the use of one or more anonymous user biometrics to anonymously link the user to the instrument.

42. A system for obtaining and using anonymous data comprising:
a. An anonymous instrument that contains a unique identifier;
b. One or more product tags that contain unique identifiers;
c. A means to communicate with the product tags; and
d. A means to communicate with the anonymous instrument.

43. The system of claim 42, wherein the means to communicate with the product tags and the anonymous instrument comprises radio frequency communication.

44. The system of claim 43, wherein the radio frequency communication is accomplished through the use of one or more radio frequency antennas.

45. The system of claim 42, further comprising a means of communicating with the user of the anonymous instrument.

46. The system of claim 45, wherein the means of communication with the user of the anonymous instrument comprises a user interface.

47. The system of claim 46, wherein the user interface comprises at least one of the following: PDA, smart phone, or kiosk.

48. The system of claim 42, further comprising a means to record data obtained from communication with the product tags and/or the anonymous instrument.

49. The system of claim 48, wherein the means to record the data obtained from communication with the product tags and/or the anonymous instrument comprises a computer system.

50. The system of claim 42, wherein the anonymous instrument omits the following information: user's name, address, social security number, date of birth, phone number, email address, and driver's license number.

51. The system of claim 48, wherein the means of recording data comprises storing the data in an electronic file.

52. The system of claim 42, further comprising transmission of the data to a computer system.

53. The system of claim 42, wherein the unique identifier comprises an alphanumeric character sequence.

54. The system of claim 42, wherein the unique identifier comprises a barcode.

55. The system of claim 42, wherein the anonymous instrument comprises a multi vendor capable device.

56. The system of claim 42, wherein the anonymous instrument comprises a radio frequency device.

57. The system of claim 42, wherein the system is capable of determining the location of the instrument.

58. The system of claim 42, wherein the system is capable of determining the location of the product tags.

59. The system of claim 42, further comprising a means to interpret the data.

60. The system of claim 59, wherein the means to interpret the data comprises a computer system.

61. The system of claim 42, further comprising encrypting the data.
